(19) United States
(12) Patent Application Publication
(10) Pub. No.: US 2026/0241654 A1
(43) Pub. Date: Aug. 20, 2026

(54) Transport system for transporting a green tire and method for inspecting a green tire

(71) Applicant: VMI Holland B.V., EPE (NL)

(72) Inventors: Evert DOPPENBERG, EPE (NL); Antonius Willibrordus Joseph STOUT, EPE (NL)

(21) Appl. No.: 19/471,670

(22) PCT Filed: Apr. 10, 2024
(86) PCT No.: PCT/NL2024/050183

§ 371 Date: Oct. 1, 2025

(30) Foreign Application Priority Data
Apr. 14, 2023 (NL) 2034581

(51) Int. Cl. B29D 30/00

(52) U.S. Cl. CPC B29D 30/0016; B29D 2030/0022; B29D 2030/0066

(57) ABSTRACT

A transport system for transporting a green tire, has a conveyor for conveying the green tire in a transport direction along a conveyance path in a conveyance plane, and an inspection station for inspecting the green tire, wherein the inspection station includes a base and a take out member that is mounted relative to said base for supporting the green tire relative to the base in a support plane, wherein the take out member is pivotable relative to the base about a pivot axis that extends parallel or substantially parallel to the transport direction between a take out position in which the take out member is located at the conveyance path, and an inspection position in which the take out member is located outside of the conveyance path and in which the support plane faces away from the conveyance path.

### BACKGROUND

The invention relates to a transport system for transporting a green tire. The invention further relates to a method for inspecting a green tire.

CN202880434U discloses a tire sorting system. The tire sorting system comprises a main line conveying device and one or more secondary line conveying devices. The sorting system comprises for each secondary line a shifting arm for urging a tire on the main line conveying device to the corresponding secondary line conveying device. The tire sorting system further comprises a sorting device at the end of each secondary line conveying device for changing the direction of the tire between two guide grooves. The tire sorting system comprises a convex curved surface consisting of rollers that is connected between the secondary line conveying device and the sorting system for erecting the tires.

The sorting system comprises a detecting device at the secondary line conveying device that detects the tire model and transmits the detected information to a computer. The computer controls sorting system such that the tire rolls along a set route to the end of the corresponding guide groove.

### SUMMARY OF THE INVENTION

A disadvantage of the known tire sorting system is that a tire cannot be reintroduced in the main line conveying system when said tire has been routed via the secondary line conveyance device to a corresponding guide groove. Hence, when a tire is erroneously routed to guide groove, said tire has to be rerouted manually. Additionally, the main line conveying system may be inaccessible or unsafe to access for an operator to inspect the green tires.

It is an object of the present invention to provide a transport system for transporting a green tire and a method for inspecting a green tire, in which an operator can more safely and/or more effectively inspect a green tire.

According to a first aspect, the present invention relates to a transport system for transporting a green tire, wherein the transport system comprises a conveyor for conveying the green tire in a transport direction along a conveyance path in a conveyance plane and an inspection station for inspecting the green tire, wherein the inspection station is arranged along the conveyance path, wherein the conveyor comprises a first conveyor section upstream of the inspection station in the transport direction and a second conveyor section downstream of the inspection station in the transport direction, wherein the inspection station comprises a base and a take out member that is mounted relative to said base for supporting the green tire relative to the base in a support plane, wherein the take out member is pivotable relative to the base about a pivot axis that extends parallel or substantially parallel to the transport direction between a take out position in which the take out member is located at the conveyance path between the first conveyor section and the second conveyor section and in which the support plane extends parallel to the conveyance plane for supporting the green tire at said conveyance plane, and an inspection position in which the take out member is located outside of the conveyance path and in which the support plane faces away from the conveyance path.

In other words, the green tire can be transferred from the conveyance path into an inspection position in which the tire is located outside the conveyance path an facing away from the transport path, i.e. facing away from the conveyor. Hence, when in the inspection position, a green tire does not obstruct or block the conveyance path. Accordingly, further green tires can be conveyed by the conveyor along the conveyance path while a green tire is being inspected at the inspection position. Thus, the green tires can be conveyed more efficiently and/or effectively. Additionally, since said inspection position is located outside the conveyance path, an operator can access the inspection position without having to reach over the conveyor. Hence, the operator can access the inspection position without interfering with the conveying of the green tires along the conveyance path. Accordingly, the operator can more safely inspect the green tire.

In a preferred embodiment thereof, the support plane is coplanar or substantially coplanar with the conveyance plane in the take out position. Hence, the green tire can be supported on both conveyor and the take out member simultaneously before being transferred to the inspection position.

In a further embodiment, the support plane extends at an angle with respect to the conveyance plane in the inspection position. In a preferred embodiment thereof, the support plane extends perpendicular to the conveyance plane in the inspection position. By rotating the support plane, the orientation of the green tire can be adjusted. More particularly, the green tire can be rotated into an upright orientation. Said upright orientation can facilitate the inspection of the green tire by an operator.

In a further embodiment, the inspection station comprises an actuator for actuating a rotation of the take out member about the pivot axis. The actuator can affect a rotation between the take out member and the carrier. The actuator may for example comprises a pneumatic cylinder.

In a further embodiment, the inspection station comprises a carrier, wherein the carrier is movable relative to the base for transferring the green tire between the take out position and the inspection position along a first trajectory, wherein the take out member is mounted to the carrier, and wherein the take out member is pivotable relative to the carrier about the pivot axis between the take out position and the inspection position. In other words, the take out member is mounted to the carrier to move together with the carrier. Accordingly, the take out member can be displaced relative to the base in addition to the rotation about the pivot axis. Hence, the take out member can conveniently be displaced between the take out position and the inspection position by moving the carrier relative to the base.

In an embodiment thereof, the take out member is movable with respect to the base along a second trajectory from the inspection position back to the take-out position. Preferably, the first trajectory and the second trajectory are the same. Hence, if the green tire is approved by the operator, the green tire can be returned or reintroduced to the conveyance path after inspection. Alternatively, if a green tire is disapproved or rejected by the operator, the tire can be removed from the inspection station.

In a further embodiment, the carrier is movable relative to the base in a first direction transverse or perpendicular to the transport direction to move the take out member along at least a part of the first trajectory. By moving the carrier transverse or perpendicular to the transport direction, the take out member can effectively moved away from the conveyance path.

In an embodiment thereof, the first direction extends away from the conveyance plane. Preferably, the first direction extends perpendicular to the conveyance plane. Alternatively, the carrier may be arranged to move the take out member away from the conveyance path in a direction in and or parallel to the conveyance plane.

In a further embodiment, the conveyance plane extends parallel to a floor surface at a conveyor height, and wherein the take out member is movable relative to the base from the take out position towards the floor surface. Preferably, said conveyor height is at least one-and-a-half meters, preferably wherein the conveyor height is at least two meters, more preferably wherein the conveyor height is at least two-and-a-half meters. Hence, the take out member can transfer the green tire from the elevated conveyor to an inspection position at or near the floor surface. In other words, the take out member can act as a lift for lowering the green tire from said elevated conveyor to the inspection position. Accordingly, the operator does not need to go up to the level of the conveyance plane and can inspect the green tire at the floor surface. Hence, working safety can be improved.

In a further embodiment, the transport system further comprises a take out drive for driving a movement of the carrier relative to the base. Hence, the take-out movement can be facilitated.

In a further embodiment, a rotation of the take out member about the pivot axis is mechanically coupled to a displacement of the carrier relative to the base. In other words, a rotation of the take out member can be affected by a displacement of the carrier relative to the base. Hence, no separate actuator is needed for affecting the rotation of the take out member.

In an embodiment thereof, the inspection station comprises a lever that is rotatable relative to the carrier about a lever rotation axis parallel to the pivot axis, wherein the inspection station further comprises a linkage that is connected to the lever at a distance spaced apart from the lever rotation axis and that is connected to the take out member at a distance spaced apart from the pivot axis, wherein the inspection station comprises a first coupling element that is mounted to the base and a second coupling element that is mounted to the lever at a distance spaced apart from the lever rotation axis, wherein the first coupling element and the second coupling element are arranged to engage upon a movement of the carrier in the first direction to affect a rotation of the lever about the lever rotation axis. Preferably, one of the first coupling element and the second coupling element is a cam, and the other one of the first coupling element and the second coupling element is a cam receiver. The lever and the linkage can effectively affect a rotation of the take out member upon engagement of the first and second coupling elements.

Alternatively, the carrier can be pivotable relative to the base. The carrier may for example be guided along a curved guide path. By pivoting the carrier relative to the base, a rotation of the take out member relative to the carrier can be omitted. Hence, the combined structure of the carrier and the take out member can be simplified.

In a further embodiment, the take out member further comprises one or more support elements for supporting the green tire in the inspection position. Preferably, said one more support elements extend perpendicular to the support plane. The one or more support elements may for example comprise beams and/or rollers.

In further embodiment, the take out member further comprises a bracket that extends parallel to the support plane for holding the green tire in the inspection position. Accordingly, the bracket can prevent the green tire from flipping over.

In a further embodiment thereof, the bracket is at least partly removable for allowing the green tire to be removed from the take out member in the inspection position.

In another embodiment, the conveyor comprises a third conveyor section between the first conveyor section and the second conveyor section in the transport direction, wherein said third conveyor section comprises a roller conveyor having a plurality rollers extending in the conveyance plane in a lateral direction transverse to the transport direction, wherein the take out member comprises two or more take out elements for supporting the green tire in a support plane, and wherein, in the take out position, the take out elements extend between the rollers of the third conveyor section in the transport direction. Accordingly, green tires can be transported by the third conveyor section when the take out member is in the take out position and when the take out member is the inspection position. Hence, further green tires can be transported in the transport direction past the inspection station while inspecting a green tire on said inspection station.

In an embodiment thereof, the take out elements each comprise one or more rollers that are rotatable about a primary roller axis that extends transverse or perpendicular to the transport direction. Hence, when in the take out position, the take out elements can form a part of the third conveyor section.

In a further embodiment thereof, each take out element comprises a plurality of rollers, and wherein the rollers of the plurality of rollers are multidirectional rollers or omnidirectional rollers. Said multidirectional or omnidirectional rollers can allow the green tire to move in a direction along the roller axis of the take out elements, i.e. transverse or perpendicular to the transport direction. Hence, when rotating the take out member from the take out position towards the inspection position, the green tire can roll over the multidirectional rollers towards the one or more support elements. Hence, sliding friction between the take out elements and green tire can be reduced, minimized or ultimately prevented. Accordingly, damage to the green tire due to sliding friction can be prevented.

In a further embodiment, the take out member is further movable into a conveyance position in which the take out elements extend between the rollers of the third conveyor section in the transport direction, and wherein the take out elements extend below the conveyance plane. In other words, the take out elements can be positioned in a position outside of the conveyance path. Accordingly, in said conveyance position, interference between the take out elements an the green tires transported by the third conveyance section can be prevented.

In a further embodiment, the transport system further comprises a weighing device for measuring a weight of the green tire. Preferably, the weighing device is arranged upstream of the inspection station in the transport direction. Optionally, said weighing device is functionally coupled to the inspection device, e.g. via a control unit. Preferably, said control unit is configured to move a green tire into the inspection position when a weight of the tire measured by weighing device is outside a predetermined range.

In a further embodiment thereof, the weighing device is arranged at the first conveyance section, wherein the first conveyance section comprises a plurality of rollers extending in the conveyance plane in a lateral direction transverse to the transport direction, wherein the weighing device comprises a weighing member that is arrange below the conveyance plane and two or more protrusions that protrude from the weighing member towards the conveyance plane and that are arranged between the rollers of the first conveyance section in the transport direction, wherein the weighing member is movable between an idle position in which the protrusions are located below the conveyance plane, and a weighing position in which the protrusions extend past the conveyance plane. Hence, when in the idle position, green tires can be transported past the weighing device in the transport direction without interference of the weighing device. Additionally, when in the weighing position, the weighing device can accurately and/or precisely measure a weight of the green tire without interference of the conveyor. Hence, measuring accuracy can be improved.

According to a second aspect, the invention relates to a method for inspecting a tire or a green tire using the transport system according to the first aspect of the invention, wherein the method comprises the steps of:
a) transporting the tire or green tire in the transport direction along the conveyance path in the conveyance plane up to the inspection station; and
b) moving the take out member from the take out position into the inspection position to move the tire or green tire from the conveyance path into the inspection position.

The method implements the transport system according to the first aspect of the invention, hence, the same technical advantages are applicable. Said advantages will not be reiterated for conciseness.

In a preferred embodiment, thereof the method further comprises the step of:
c) inspecting the green tire in the inspection position.

In a further embodiment, the method further comprises the step of:
d) moving the take out member from the inspection position to the take out position to move the tire or green tire into the conveyance path; and
e) transporting the tire or green tire away from the inspection station in the transport direction along the conveyance path in the conveyance plane. In other words, the tire or green tire can be returned or reintroduced in the conveyance path after inspection.

In a further embodiment, the conveyor comprises a third conveyor section between the first conveyor section and the second conveyor section in the transport direction, wherein said third conveyor section comprises a roller conveyor having a plurality rollers extending in the conveyance plane in a lateral direction transverse to the transport direction, wherein the take out member comprises two or more take out elements for supporting the tire or the green tire in a support plane, and wherein, in the take out position, the take out elements extend between the rollers of the third conveyor section in the transport direction. The positioning of the take out elements between the rollers in the take out position can facilitate removing the tire or green tire from the third conveyor section.

In an embodiment thereof, the method comprises the step of, prior to step a), positioning the take out elements in a conveyance position below the conveyance plane, and wherein the method further comprises the step of, between steps a) and b), moving the take out elements from the conveyance position into the take out position. Hence, while transporting the tires or green tires during step a) the take out elements can be kept out of the conveyance path.

In another embodiment, the method comprises the step of weighing the tire or green tire prior to step b). Preferably, step b) is performed in response to a measured weight being outside a predetermined interval.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a transport system for transporting a green tire according to an embodiment of the present invention;

FIG. 2 shows a section view of the transport system according to the line II-II in FIG. 1 during an exemplary step of a method for inspecting the green tire;

FIG. 3 shows the section view of FIG. 2 during a further exemplary step of the method for inspecting the green tire;

FIG. 4 shows a front view of the transport system according to the line IV-IV in FIG. 1 during another exemplary step of the method for inspecting the green tire;

FIGS. 5 and 6 show the front view of FIG. 4 during further exemplary steps of the method for inspecting the green tire;

FIG. 7 shows a section view according to the line VII-VII in FIG. 4;

FIG. 8 shows a section view according to the line VIII-VIII in FIG. 5;

FIG. 9 shows an alternative transport system according to a further embodiment of the present invention; and

FIG. 10 shows a detailed view of the transport system according to the circle X in FIG. 1.

### DETAILED DESCRIPTION OF THE INVENTION

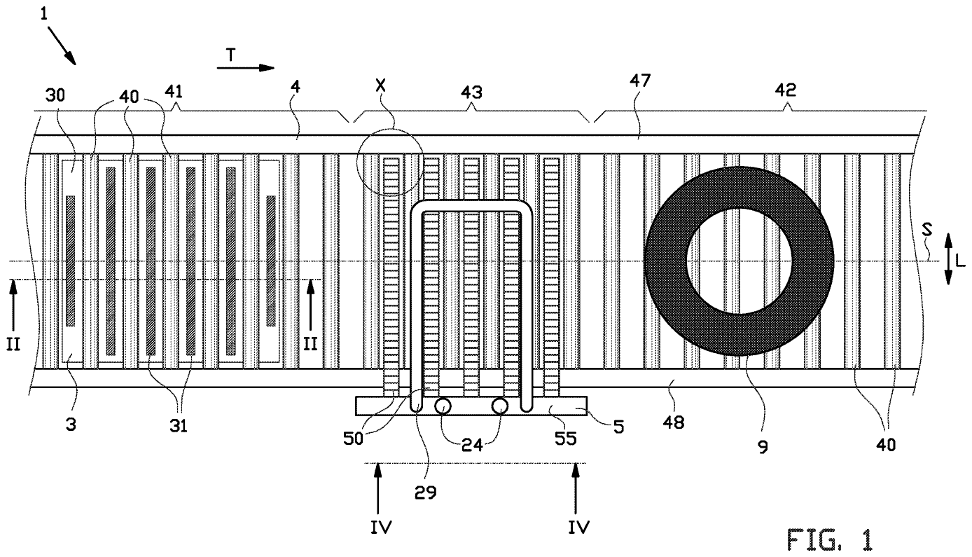

FIGS. 1-9 show a transport system 1 for transporting an unvulcanized or green tire 9. The transport system 1 comprises a conveyor 4 for supporting the green tire 9 in a conveyance plane C. The conveyor 4 is further arranged for conveying the green tire 9 in a transport direction T along a conveyance path S in said conveyance plane C. The conveyance path S, as shown in FIGS. 1-5 is a straight or substantially straight path. Alternatively, the conveyance path S may for example comprise one or more bends or curves.

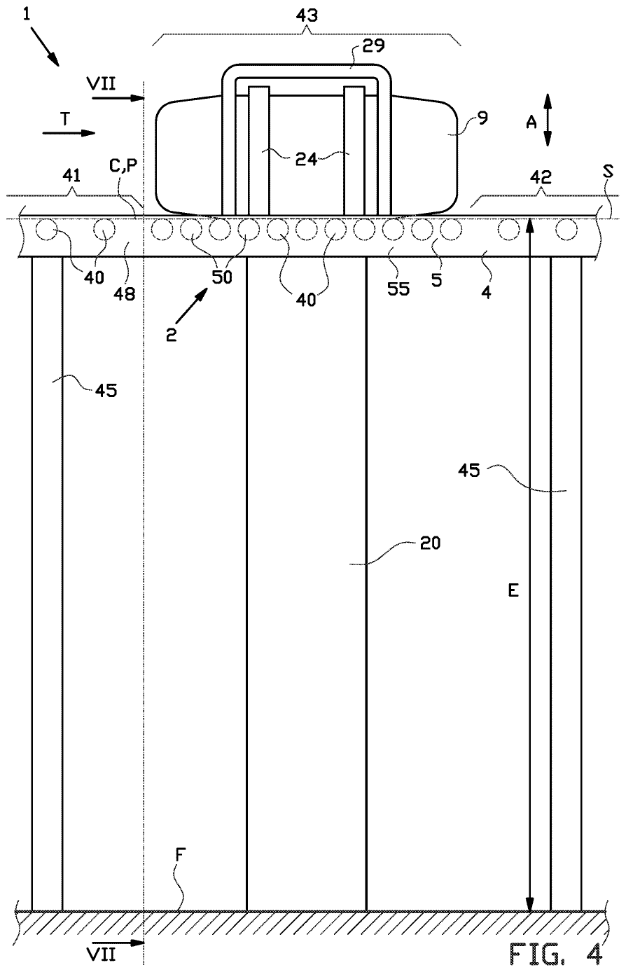

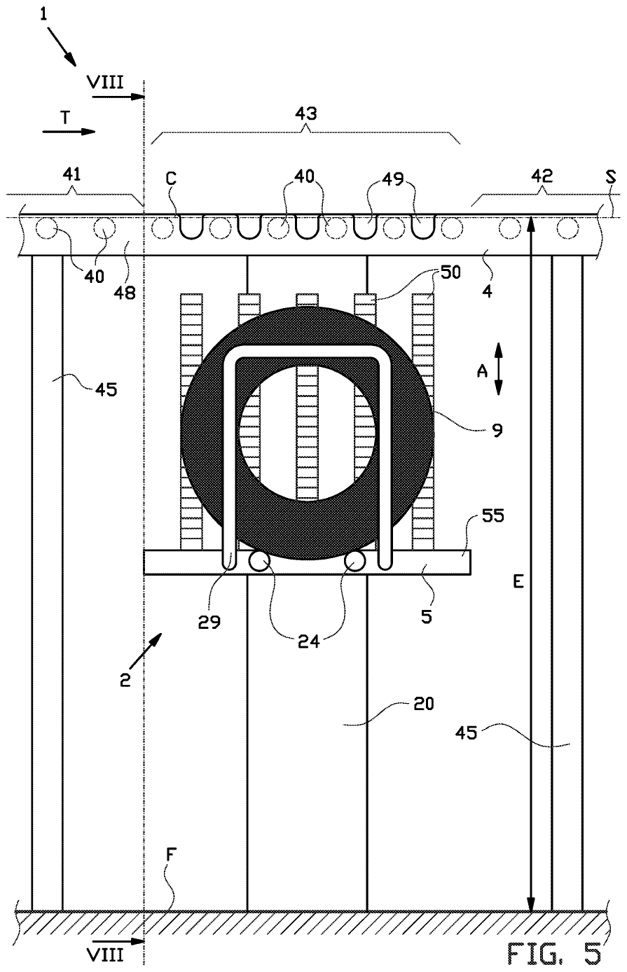

As is shown in FIGS. 4 and 5, the conveyor 4 is mounted to and/or supported on a frame 45. The conveyor 4 is elevated relative to a floor surface F, e.g. a factory floor surface, by a conveyor height E. Preferably, said conveyor height E is at least one and a half meters. More preferably, said conveyor height E is at least two meters. More preferably, the conveyor height E is at least two and a half meters.

As is best shown in FIGS. 1, 4 and 5, the conveyor 4 comprises a first conveyor section 41, a second conveyor section 42 and a third conveyor section 43. The third conveyor section 43 is arranged between the first conveyor section 41 and the second conveyor section 42 in the transport direction T. More particularly, the first conveyor section 41 is arranged upstream of the third conveyor section 43 in the transport direction T. Accordingly, the second conveyor section 42 is arranged downstream of the third conveyor section 43 in the transport direction T.

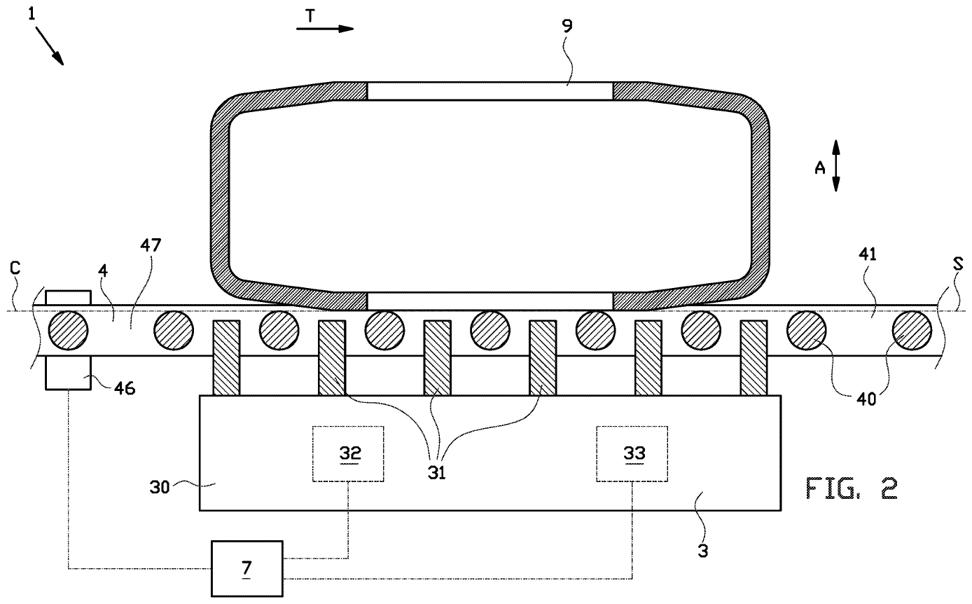

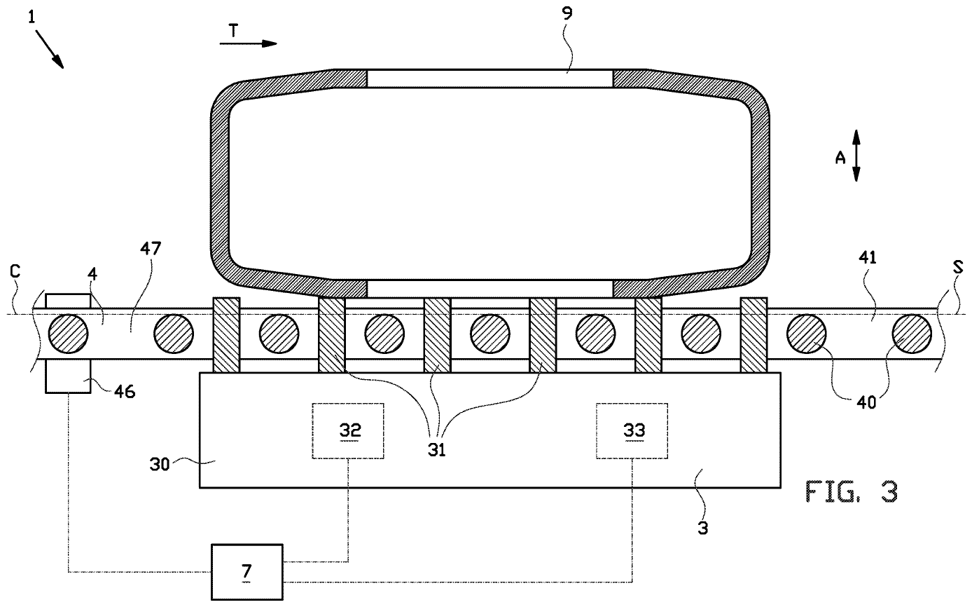

In the embodiment as shown in FIGS. 1-5, the first conveyor section 41, the second conveyor section 42 and the third conveyor section 43 comprise roller conveyors having a plurality of rollers 40 for conveying the green tire in the transport direction T. At least a part of said rollers 40 are driven rollers. In particular, as is shown in FIGS. 2 and 3, the conveyor 4 may comprises a conveyor drive 46 for driving a rotation of the rollers 40. Optionally, the rollers 40 of the first conveyor section 41, the second conveyor section 42 and the third conveyor section 43 may be driven in rotation by the same conveyor drive 46. Alternatively, the conveyor 4 may comprise multiple conveyor drives for driving the rollers of the conveyor sections 41, 42, 43.

The rollers 40 extend parallel to the conveyance plane C in a lateral direction L transverse or perpendicular to the transport direction T. Alternatively, at least one of the first conveyor section 41 the second conveyor section 42 and the third conveyor section 43 may for example comprise a belt conveyor.

As is best shown in FIG. 1, the conveyor 4 comprises a first support beam or first support structure 47 at a first side of the conveyance path S and a second support beam or second support structure 48 on a second side of the conveyance path S opposite to the first side for supporting the rollers 40 of the first conveyor section 41, the second conveyor section 42 and the third conveyor section 43. The rollers 40 extend in the lateral direction L between said first support structure 47 and said second support structure 48. More particularly, the rollers 40 extend from the first support structure 47 to the second support structure 48.

As is further shown in FIGS. 1 and 4-8, the transport system 1 comprises an inspection station 2 for inspecting the green tire 9 that is transported on the conveyor 4. The inspection station 2 is arranged along the transport path S at the third conveyor section 43. In other words, the inspection station 2 is arranged between the first conveyor section 41 and the second conveyor section 42 in the transport direction T.

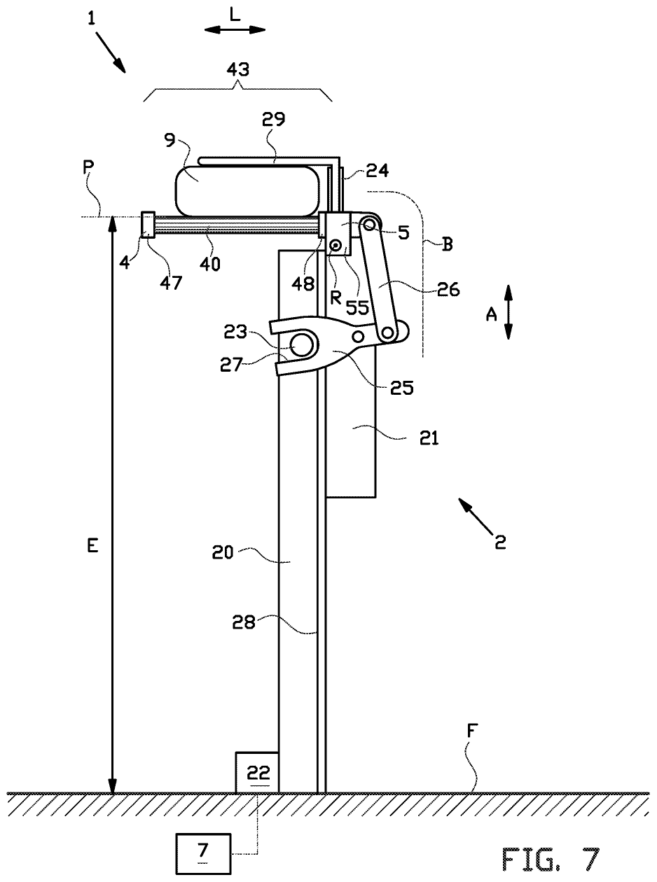

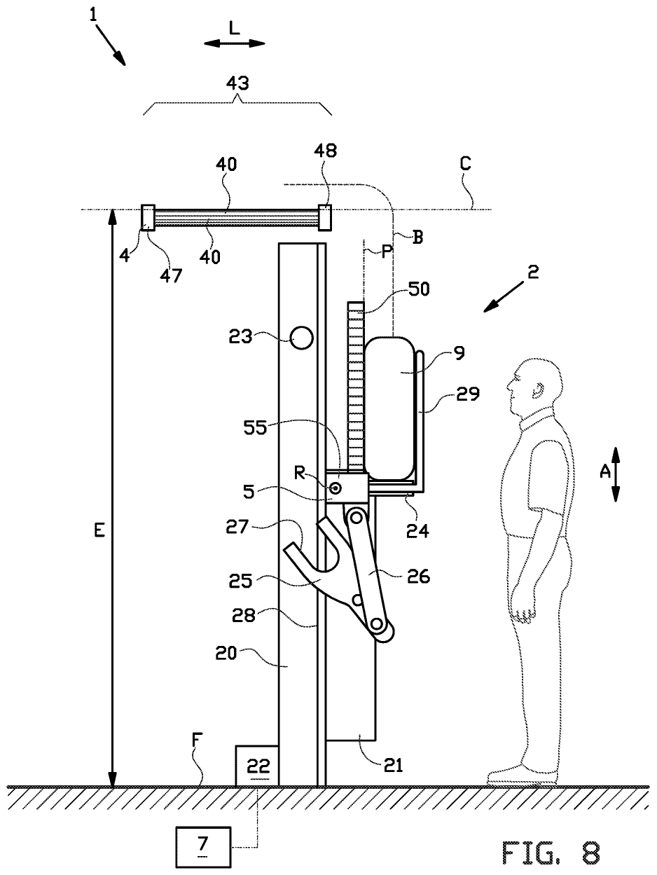

The inspection station 2 comprises a base 20 and a take out member 5 that is movable relative to the base 20 between a take out position, as is shown in FIGS. 4 and 7, and an inspection position, as is shown in FIGS. 5 and 8. The take out member 5 is arranged for supporting the green tire 9 in a support plane P. More particularly, the take out member 5 is arranged for supporting a side surface of the green tire 9 in said support plane P.

In the take out position, the take out member 5 is located at the conveyance path S. More particularly, in the take out position, the take out member 5 is arranged to support the green tire 9 at the conveyance plane C. In said take out position, the support plane P extends parallel to the conveyance plane C. Preferably, in the take out position, the support plane P and the conveyance plane C are coplanar or substantially coplanar.

In the inspection position, the take out member 5 is located outside of the conveyance path S. As is best shown in FIG. 8, the support plane P faces away from the conveyance path S. In particular, the support plane P faces away from the conveyor 4. In the inspection position, the support plane P extends at an angle with respect to the conveyance plane C. In other words, the support plane P has been rotated relative to the conveyance plane C. Preferably, the support plane P extends perpendicular to the conveyance plane C in the inspection position.

The take out member 5 is movable along a first trajectory B. The take out member 5 is arranged for moving, displacing or transferring the green tire 9 along said first trajectory B from the take out position to the inspection position. Accordingly, the take out member 5 is arranged for

Moving or transferring the green tire 9 in an opposite direction along the first trajectory B from the inspection position to the take out position. Alternatively, the take out member 5 may be moved from the inspection position to the take out position along a second trajectory different from the first trajectory B.

In the embodiment as shown, the movement of the take out member 5 comprises both a translation and a rotation between the take out position and the inspection position. Alternatively, the movement of the take out member 5 from the take out position to the inspection position may comprises a translation or displacement, or a rotation only.

The inspection station 2 comprises a carrier 21 that is movable relative to the base 20. The take out member 5 is mounted to said carrier 21. The carrier 21 is movable between the conveyance plane C and the floor surface F. The inspection station 2 comprises a guide or guide rail 28 that is mounted to the base 20 for guiding the carrier 21 in a first direction A. The inspection station 2 comprises a take out drive 22 for driving a movement of the carrier in the first direction A, i.e. along the guide rail 28. Said take out drive 22 may for example comprises a spindle or a linear actuator. Alternatively, the take out drive 22 may for example comprises a chain drive.

In the embodiment as shown, said first direction A extends perpendicular or substantially perpendicular to the conveyance plane C. In other words, the first direction A is a vertical or a substantially vertical direction. Alternatively, the carrier 21 may be movable in a different direction transverse or perpendicular to the transport direction T.

As is shown in FIGS. 7 and 8, the take out member 5 is rotatable or pivotable relative to the carrier 21 about a pivot axis R. More particularly, the take out frame 55 is rotatable or pivotable relative to the carrier 21 about said pivot axis R. Accordingly, the take out member 5 may be rotatable or pivotable relative to the base 20. The pivot axis R extends parallel or substantially parallel to the conveyance plane C. Preferably, the pivot axis R extends parallel or substantially parallel to the transport direction T.

The take out member 5 comprises a plurality of take out elements 50 for supporting the green tire in the support plane P. The take out member 5 further comprises a take out frame 55 for supporting the said take out elements 50. The take out elements 50 extend away from said take out frame 55. More particularly, the take out elements 50 extend parallel to or in the support plane P.

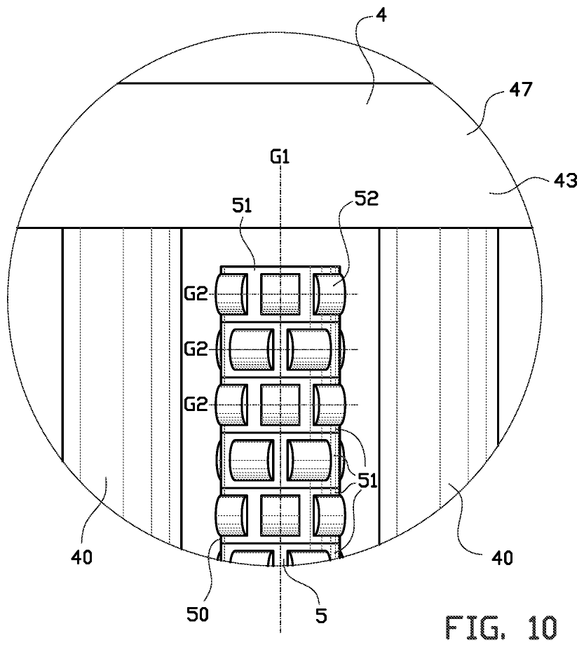

As is best shown in FIG. 10, the take out elements 50 each comprise a plurality of primary rollers 51 that are rotatable about a primary roller axis G1. Alternatively, the take out elements may for example each comprise a single roller that is rotatable about the primary roller axis G1. Said primary roller axis G1 extends parallel to the support plane P. The primary roller axis G1 extends transverse or perpendicular to the transport direction T.

As is further shown in FIG. 10, the primary rollers 51 are bi-directional, multidirectional or omnidirectional rollers. More particularly, each primary roller 51 comprises a plurality of secondary rollers 52 that are each rotatable relative to the primary roller 51 about a respective secondary roller axis G2. Said secondary roller axes G2 are tangent or tangential to a circumferential direction about the primary roller axis G1. In other words, the projection of a respective secondary roller axis G2 on the primary roller axis G1 extends transverse or perpendicular to said primary roller axis G1. Consequently a circumferential direction of the secondary rollers 52 may be parallel or substantially parallel to the primary roller axis G1. Accordingly, the secondary rollers 52 may allow the green tire 9 to roll along the primary rollers 51 of the take out elements 50 in a direction parallel to the primary roller axis G1.

As is further shown in FIGS. 1 and 4-8, the take out member 5 comprises two support member 24 for supporting the green tire 9 in the inspection position. More particularly, said support members 24 are arranged for supporting a circumferential surface of the green tire 9. In the embodiment as shown, the support members 24 comprise circular beams or rollers for supporting the green tire 9. Alternatively, the take out member 5 may for example comprise a plurality of support members 24 or a single support member for supporting the green tire 9. The support members 24 extend in a direction perpendicular or substantially perpendicular to the support plane P

The take out member 5 is further provided with an arm or bracket 29 for holding the green tire 9. In particular, the bracket 29 is arranged for facing and/or abutting a side wall of the green tire 9 opposite to the side wall of the green tire 9 that is supported in the support plane P. The bracket 29 is mounted to the take out frame 55. The bracket 29 extends parallel or substantially parallel to the take out elements 50. Preferably, the take out elements 50 and the bracket 29 are mutually spaced apart over a distance that substantially corresponds to a width of the green tire 9. Optionally, the mutual distance between the bracket 29 and the take out elements 50 may be adaptable or adjustable.

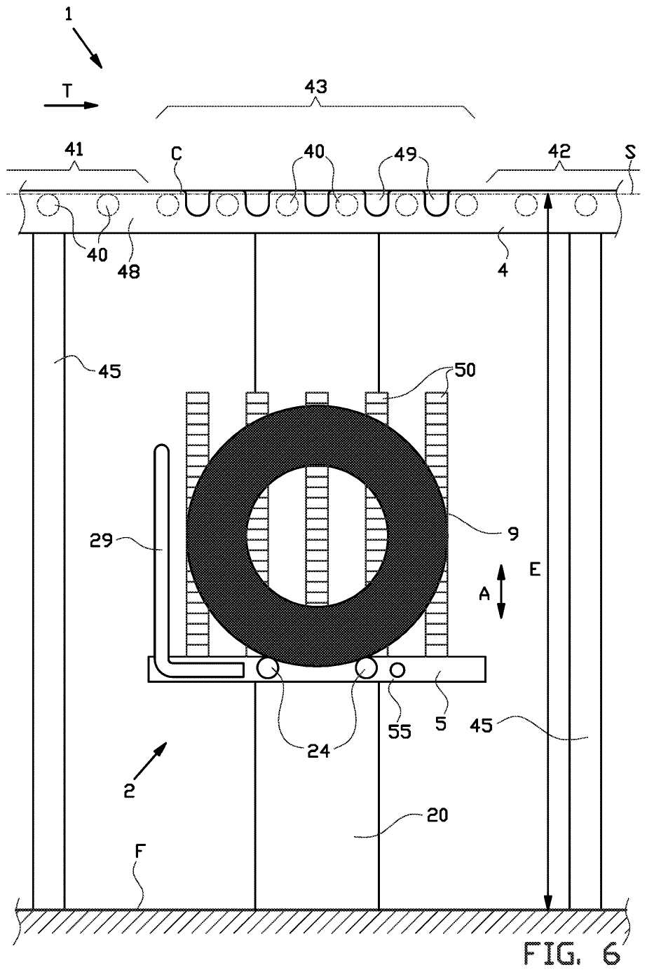

As is further shown in FIG. 6, the bracket 29 is at least partly removable to allow the green tire 9 to be removed from the take out member 5. In the embodiment as shown the bracket 29 has been rotated away from the green tire 9 about a bracket rotation axis that extends in the first direction A.

As is shown in FIG. 6, the take out member 5 may be lowered relative to the inspection position into a removal position. Said removal position may facilitate the removal of the green tire 9 from the take out member 5.

As is shown in FIGS. 4 and 7, in the take out position, the take out elements 50 extend between the rollers 40 of the third conveyor section 43 in the transport direction T. In other words, the take out elements 50 are interposed between the rollers 40 of the third conveyor section 43. Preferably, the second support structure 48 comprises cut-outs or recesses 49 for receiving the take out elements 50. Alternatively, the second support structure 48 may for example be interrupted or discontinued at the third conveyor section 43. Accordingly, the rollers 40 of the third conveyor section 43 may be supported by the first support structure 47 only.

In the embodiment as shown, the support plane P is co-planar or substantially co-planar with the conveyance plane C in the take out position. In other words, the rollers 40 of the third conveyor section 43 and the take out elements 50 extend parallel or substantially parallel. Alternatively, the support plane P may for example extend at an oblique angle with respect to the conveyance plane C such that the green tire 9 is urged towards the support elements 24 upon an upward movement of the take out member 5 relative to the rollers 40 of the third conveyor section 43.

The take out member 5 may further be movable into a conveyance position in which the take out elements 50 are arranged below the conveyance plane C. In other words, in said conveyance position, the green tire 9 can be supported by the rollers 40 of the third conveyor section 43 only.

As is further shown in FIGS. 7 and 8, the inspection station 2 comprises a mechanical coupling between the movement or displacement of the carrier 21 in the first direction A and the rotation of the take out member 5 about the pivot axis R. Alternatively, the inspection station 2 may for example comprise an actuator for actuating a rotation of the take out member 5 relative to the carrier 21.

The mechanical coupling comprises a lever that is rotatable relative to the carrier 21 about a lever rotation axis. Said lever rotation axis extends parallel or substantially parallel to the pivot axis R. The mechanical coupling further comprise a linkage 26 that is connected between the take out member 5 and the lever 25. More particularly, the linkage 26 is connected to the lever 25 at a distance spaced apart from the lever rotation axis. Accordingly, the linkage 26 is connected to the take out member 5 at a distance spaced apart from the pivot axis R. In other words, the linkage 26 may couple a rotation of the lever 25 about the lever axis to the rotation of the take out member 5 about the pivot axis R.

The inspection station 2 further comprises a protrusion, nook or cam 23 that is mounted to the base 20. Said cam 23 protrudes from the base in the direction of the pivot axis R. The lever 25 is provided with a recess or cam receiver 27 to cooperate with the cam 23. The cam receiver 27 is arranged at a distance spaced apart from the lever rotation axis. Alternatively, a cam may be provided on the lever 25 and a cam receiver may be provided on the base 20.

The cam receiver 27 is arranged to engage the cam 23 upon an movement of the carrier 21 towards the conveyance plane in the first direction A. When the cam receiver 27 has engaged the cam 23 a further movement in the first direction A can cause the lever 25 to rotate about the lever rotation axis.

As is shown in FIGS. 1-3, the transport system 1 further comprises a weighing device 3 for weighing the green tire 9. Preferably, the weighing device 3 is arranged upstream of the inspection station 2 in the transport direction T. In the embodiment as shown in FIGS. 1-3, the weighing device 3 is arranged at the first conveyor section 41.

The weighing device 3 comprises a weighing member 30 that extends under the first conveyor section 41. The weighing member 30 extends parallel or substantially parallel to the conveyance plane C. The weighing device 3 further comprises two or more protrusions 31 that extend away from the weighing member 30 and towards the conveyance plane C. The protrusions 31 are arranged to be inserted between the rollers 40 of the first conveyor section 41.

The weighing member 30 is movable between an idle position, as shown in FIG. 2, and a weighing position as shown in FIG. 3. In the idle position, the protrusions 31 are located below the conveyance plane C. In other words, the protrusions are receded with respect to the rollers 40 of the first conveyor section 41. Accordingly, the green tire 9 may be transported in the transport direction T by the first conveyor section 41 without being obstructed by the protrusions 31.

In the weighing position, the protrusions 31 extend up to or past the conveyance plane C. Preferably, the protrusions 31 protrude from between the rollers 40 of the first conveyor section 41. Accordingly, the green tire 9 may be supported by the protrusions 31 only.

The weighing device 3 further comprises a weight sensor 33 for measuring a parameter indicative of the weight of the green tire 9. For example, said weight sensor 33 may comprise a load cell for measuring the weight of the green tire 9.

The weighing device 3 comprises a weighing drive 32 for moving the weighing member 30 back and forth between the weighing position and the idle position.

In the embodiment as shown in FIGS. 2 and 3, the weight sensor 33 is functionally and/or operationally connected to a control unit 7. Preferably, the control unit is further operationally and/or functionally coupled to the take out drive 22. The control unit 7 may for example be configured to control the take out drive 22 for automatically transferring a green tire 9 to the inspection position in response to a measured weight of said green tire 9 being outside a predetermined range.

Preferably, the weighing drive 32 is functionally and/or operably connected to the control unit 7. For example, the control unit 7 may be configured for controlling the weighing drive 32 to move the weighing member from the idle position to the weighing position for each green tire 9 that is being transported in the transport direction T on the first conveyor 41.

A method for transporting a green tire 9 is described below using FIGS. 1-8. The below method may be equally suitable for transporting a tire, i.e. a vulcanized tire.

As is shown in FIG. 2, the green tire 9 has been transported in the transport direction T along the conveyance path S up tot the weighing device 3 at the first conveyor section 43. The weighing member 30 is in the idle position. As is shown in FIG. 3, the weighing drive 32 is actuated to move the weighing member 30 from the idle position into the weighing position. The green tire 9 is now supported on the protrusions 31. The weight of the green tire 9 is now measured by the sensor 33. In particular, the sensor 33 sends a signal indicative of the weight of the green tire 9 to the control unit 7. After measuring the weight of the green tire 9, the weighing drive 32 is actuated to move the weighing member 32 back to the idle position. Subsequently, the green tire 9 is transported further along the conveyance path S in the transport direction T by the first conveyor section 41.

Alternatively, the weighing member 30 may initially be arranged in the weighing position for receiving the green tire 9 directly from a manipulator (not shown). After measuring the weight of the green tire 9, the weighing member 30 is moved into the idle position and the green tire is transported further in the transport direction T as described above.

As is shown in FIGS. 4 and 7, the green tire 9 has been transported in the transport direction T by the first conveyor section 41 up to the inspection station 2, while the take out member 5 is arranged in the conveyance position at or below the conveyance plane C. More particularly, the support plane P is arranged at or below the conveyance plane C. Preferably, the support plane P extends parallel to the conveyance plane C.

The take out member 5 has been moved into the take out position. The support plane P and the conveyance plane C are coplanar or substantially coplanar. Preferably, a side surface of the green tire 9 is at least partly supported on the take out elements 50.

As is shown in FIGS. 5 and 8, the take out member 5 has been moved from the take out position to the inspection position. The carrier 21 has been displaced in the first direction A towards the floor surface F. Accordingly, coupling mechanism has rotated the take out member 5 about the pivot axis R. In other words, the support plane P has been rotated relative to the conveyance plane C about the pivot axis R. Preferably, the support plane P extends perpendicular or substantially perpendicular to the conveyance plane C. The support plane P faces away from the conveyor 4. The green tire 9 is now supported on the support elements 24.

As is shown in FIG. 8, in the inspection position, an operator inspects the green tire 9 for irregularities, defects, failures or other quality issues. While the green tire 9 is located in the inspection position, further green tires 9 may be transported in the transport direction T along the inspection path S at the third conveyor section 43.

Optionally, as is shown in FIG. 6, when the operator finds an irregularity, a defect, a failure or any other quality issue in the green tire 9, the take out member 5 is moved in the first direction A int the removal position. Subsequently, the bracket 29 opened or removed to allow access to the green tire 9 and the green tire 9 is removed to be scrapped or discarded.

Alternatively, when the operator finds no irregularities, defects, failures or other quality issues in the green tire 9, said the take out member 5 is moved from the inspection position to the take out position as shown in FIGS. 4 and 7 to transfer the green tire 9 back to the conveyance path S. The take out member 5 is subsequently moved into the conveyance position.

As is shown in FIG. 1, the green tire 9 is now transported further along the in the transport direction T along the conveyance path S by the second conveyor section 42.

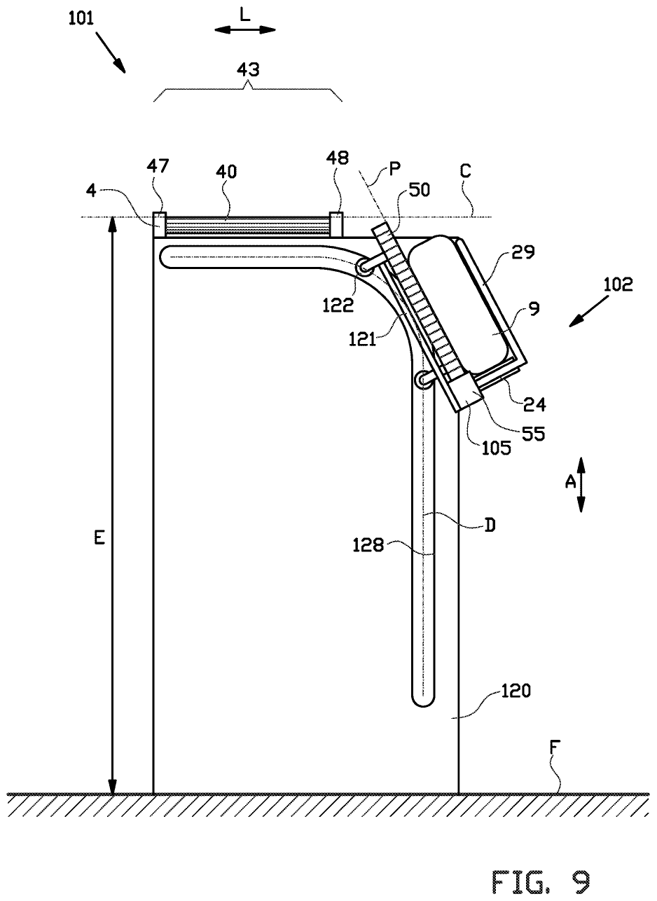

FIG. 9 shows an alternative transport system 101 comprising an alternative inspection station 102 according to a further embodiment of the present invention. The alternative inspection station 102 differs from the previously described inspection station 2 in that the base 120 comprises a curved guide track 128. The carriage 121 comprises two guide followers 122 that are arranged to cooperate with the guide track 128 for guiding said carriage 121 along a second trajectory D to transfer the green tire 9 from the take out position to the inspection position.

Additionally or alternatively, the carriage 121 may be driven by a chain drive or belt drive (not shown) that extends at least partly along the second trajectory D.

It is to be understood that the above description is included to illustrate the operation of the preferred embodiments and is not meant limit the scope of the invention. From the above discussion, many variations will be apparent to one skilled in the art that would yet be encompassed by the scope of the present invention.

### REFERENCE NUMERALS

1 transport system
2 inspection station
20 base
21 carriage
22 take out drive
23 cam
24 support element
25 lever
26 linkage
27 notch
28 guide
29 bracket
3 weighing device
30 weighing member
31 protrusion
32 weighing drive
33 weight sensor
4 conveyor
40 roller
41 first conveyor section
42 second conveyor section
43 third conveyor section
45 frame
46 conveyor drive
47 first support structure
48 second support structure
49 recess
5 take out member
50 take out element
51 primary roller
52 secondary roller
55 take out frame
7 control unit
9 green tire
102 alternative inspection station
120 base
121 carriage
122 guide follower
128 guide track
105 alternative take out member
A first direction
B first trajectory
C conveyance plane
D second trajectory
E conveyor height
F floor surface
L lateral direction
G1 primary roller axis
G2 secondary roller axis
P support plane
R pivot axis
S conveyance path
T transport direction

1-30. (canceled)

31. A transport system for transporting a green tire, wherein the transport system comprises a conveyor configured for conveying the green tire in a transport direction along a conveyance path in a conveyance plane, and an inspection station configured for inspecting the green tire, wherein the inspection station is arranged along the conveyance path, wherein the conveyor comprises a first conveyor section upstream of the inspection station in the transport direction and a second conveyor section downstream of the inspection station in the transport direction, wherein the inspection station comprises a base and a take out member that is mounted relative to said base for supporting the green tire relative to the base in a support plane, wherein the take out member is pivotable relative to the base about a pivot axis that extends parallel or substantially parallel to the transport direction between a take out position in which the take out member is located at the conveyance path between the first conveyor section and the second conveyor section and in which the support plane extends parallel to the conveyance plane for supporting the green tire at said conveyance plane, and an inspection position in which the take out member is located outside of the conveyance path and in which the support plane faces away from the conveyance path.

32. The transport system according to claim 31, wherein the support plane and the conveyance plane are coplanar in the take out position.

33. The transport system according to claim 31, wherein, in the inspection position, the support plane extends at an angle with respect to the conveyance plane.

34. The transport system according to claim 33, wherein, in the inspection position, the support plane extends perpendicular or substantially perpendicular to the conveyance plane.

35. The transport system according to claim 31, wherein the inspection station comprises an actuator configured for actuating a rotation of the take out member about the pivot axis.

36. The transport system according to claim 31, wherein the inspection station comprises a carrier, wherein the carrier is movable relative to the base for transferring the green tire between the take out position and the inspection position along a first trajectory, wherein the take out member is mounted to the carrier, and wherein the take out member is pivotable relative to the carrier about the pivot axis between the take out position and the inspection position.

37. The transport system according to claim 36, wherein the carrier is movable relative to the base in a first direction transverse or perpendicular to the transport direction to move the take out member along at least a part of the first trajectory.

38. The transport system according to claim 37, wherein the first direction extends perpendicular to the conveyance plane.

39. The transport system according to claim 36, wherein the conveyance plane extends parallel to a floor surface at a conveyor height, and wherein the take out member is movable relative to the base from the take out position towards the floor surface.

40. The transport system according to claim 39, wherein the conveyor height is at least one-and-a-half meters, or wherein the conveyor height is at least two meters, or wherein the conveyor height is at least two-and-a-half meters.

41. The transport system according to claim 36, wherein the transport system further comprises a take out drive for driving a movement of the carrier relative to the base.

42. The transport system according to claim 37, wherein a rotation of the take out member about the pivot axis is mechanically coupled to a displacement of the carrier relative to the base.

43. The transport system according to claim 42, wherein the inspection station comprises a lever that is rotatable relative to the carrier about a lever rotation axis parallel to the pivot axis, wherein the inspection station further comprises a linkage that is connected to the lever at a distance spaced apart from the lever rotation axis and that is connected to the take out member at a distance spaced apart from the pivot axis, wherein the inspection station comprises a first coupling element that is mounted to the base and a second coupling element that is mounted to the lever at a distance spaced apart from the lever rotation axis, wherein the first coupling element is arranged to engage the second coupling element upon a movement of the carrier in the first direction to affect a rotation of the lever about the lever rotation axis, or wherein one of the first coupling element and the second coupling element is a cam, and wherein the other one of the first coupling element and the second coupling element is a cam receiver.

44. The transport system according to claim 31, wherein the take out member further comprises one or more support elements configured for supporting the green tire in the inspection position.

45. The transport system according to claim 44, wherein the one or more support elements extend perpendicular to the support plane.

46. The transport system according to claim 31, wherein the take out member further comprises a bracket that extends parallel to the support plane for holding the green tire in the inspection position.

47. The transport system according to claim 46, wherein the bracket is at least partly removable for allowing the green tire to be removed from the take out member.

48. The transport system according to claim 31, wherein the conveyor comprises a third conveyor section between the first conveyor section and the second conveyor section in the transport direction, wherein said third conveyor section comprises a roller conveyor having a plurality rollers extending in the conveyance plane in a lateral direction transverse to the transport direction, wherein the take out member comprises two or more take out elements configured for supporting the green tire in a support plane, and wherein, in the take out position, the take out elements extend between the rollers of the third conveyor section in the transport direction.

49. The transport system according to claim 48, wherein the take out elements each comprise one or more rollers that are rotatable about a primary roller axis that extends transverse or perpendicular to the transport direction.

50. The transport system according to claim 49, wherein each take out element comprises a plurality of rollers, and wherein the rollers of the plurality of rollers are multidirectional rollers.

51. The transport system according to claim 48, wherein the take out member is further movable into a conveyance position in which the take out elements extend between the rollers of the third conveyor section in the transport direction, and wherein the take out elements extend below the conveyance plane.

52. The transport system according to claim 31, wherein the transport system further comprises a weighing device configured for measuring a weight of the green tire.

53. The transport system according to claim 52, wherein the weighing device is arranged upstream of the inspection station in the transport direction.

54. The transport system according to claim 53, wherein the weighing device is arranged at the first conveyance section, wherein the first conveyance section comprises a plurality of rollers extending in the conveyance plane in a lateral direction transverse to the transport direction, wherein the weighing device comprises a weighing member that is arranged below the conveyance plane, and two or more protrusions that protrude from the weighing member towards the conveyance plane and that are arranged between the rollers of the first conveyance section in the transport direction, wherein the weighing member is movable between an idle position in which the protrusions are located below the conveyance plane, and a weighing position in which the protrusions extend past the conveyance plane.

55. A method for inspecting a tire or a green tire using the transport system according to claim 31, wherein the method comprises the steps of:
a) transporting the tire or green tire in the transport direction along the conveyance path in the conveyance plane up to the inspection station; and
b) moving the take out member from the take out position into the inspection position to move the tire or green tire from the conveyance path into the inspection position.

56. The method according to claim 55, wherein the method further comprises the step of:
c) inspecting the tire or green tire in the inspection position.

57. The method according to claim 56, wherein the method further comprises the steps of:
d) moving the take out member from the inspection position to the take out position to move the tire or green tire into the conveyance path; and
e) transporting the tire or green tire away from the inspection station in the transport direction along the conveyance path in the conveyance plane.

58. The method according to claim 55, wherein the conveyor comprises a third conveyor section between the first conveyor section and the second conveyor section in the transport direction, wherein said third conveyor section comprises a roller conveyor having a plurality rollers extending in the conveyance plane in a lateral direction transverse to the transport direction, wherein the take out member comprises two or more take out elements for supporting the tire or green tire in a support plane, and wherein, in the take out position, the take out elements extend between the rollers of the third conveyor section in the transport direction.

59. The method according to claim 58, wherein the method comprises the step, prior to step a), of positioning the take out elements in a conveyance position below the conveyance plane, and wherein the method further comprises, between steps a) and b), moving the take out elements from the conveyance position into the take out position.

60. The method according to claim 55, wherein, prior to step b), the method comprises the step of weighing the tire or green tire.
